(19) United States
(12) Patent Application Publication
(10) Pub. No.: US 2019/0311070 A1
(43) Pub. Date: Oct. 10, 2019

(54) METHOD AND APPARATUS FOR GENERATING VISUAL SEARCH QUERIES AUGMENTED BY SPEECH INTENT

(71) Applicant: Microsoft Technology Licensing, LLC, Redmond, WA (US)

(72) Inventors: Li Huang, Sammamish, WA (US); Houdong Hu, Redmond, WA (US); Meenaz Merchant, Kirkland, WA (US)

(21) Appl. No.: 15/947,564

(22) Filed: Apr. 6, 2018

(51) Int. Cl. G06F 17/30; G06K 9/32; G10L 15/26; G06N 5/02

(52) U.S. Cl. CPC G06F 17/30976; G06N 5/02; G10L 15/26; G06K 9/3241

(57) ABSTRACT

A method for using a speech signal to augment a visual search includes processing the image data to determine an image search intent. Concurrently with processing the image data, the method processes the speech signal to determine at least one speech search intent. The method generates a search query by combining keywords and/or the image from the image search intent with keywords from the speech search intent. The method then performs a search based on the generated query and reports the results of the search. The method generates the image search intent by applying the image data to a knowledge base and generates the speech search intent by converting the speech to text and applying the text to a cognition service.

### BACKGROUND

Many current visual search products expend considerable resources to determine the content of an image in order to perform a search based on the image. Once the image content has been determined, current visual search products perform similar searches, for example finding images of objects in websites or in an image search database that are similar to the determined image content. These services may automatically detect the image content or determine the image content based on user-specified bounding boxes. Image searches may also predict a search intent based on image captions or based on a context of the image. For example, a visual search product may interpret that an image of food on a table is a request for a search of nearby restaurants. Understanding the search intent behind an image is a basic step for visual search.

One challenge for visual search is understanding what users are searching for. For example, if a user takes a picture of pizza, the search may be for a nearby restaurant that sells pizza, a question regarding the nutritional value of the pizza, a recommendation for the best pizza in city, or even who invented pizza. There are many possible visual search intents for a given image. In addition, there are many different types of images that may need to be analyzed. For example, images with multiple objects, images taken from different points of view and/or images having different resolutions may present challenges to an image search service. Understanding the search intent of the user may improve the accuracy and relevance of visual searches.

### SUMMARY

This summary is not an extensive overview of the claimed subject matter. It is intended to neither identify key elements of the claimed subject matter nor delineate the scope of the claimed subject matter. Its sole purpose is to present some concepts of the claimed subject matter in a simplified form as a prelude to the more detailed description that is presented later.

A method and apparatus for using a speech signal to augment a visual search includes processing the image data to determine an image search intent. Speech signal data is processed concurrently with processing the image data to determine a speech search intent. The method and apparatus generates a search query by combining keywords from the image search intent and the speech search intent. The method and apparatus then performs a search based on the generated query and reports the results of the search.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description when considered in conjunction with the drawings.

### BRIEF DESCRIPTION OF THE DRAWINGS

FIG. 1 is a functional block diagram showing example components of a communication network combined visual and speech search query generator.

FIG. 2A is a functional block diagram of an example combined visual and speech search system.

FIGS. 2B and 2C are image diagrams useful for describing the operation of the visual and speech search system shown in FIG. 2A

FIGS. 3A and 3B are flow-chart diagrams useful for describing example embodiments.

FIGS. 4 and 5 are a block diagrams of example hardware that may be used in an embodiment.

### DETAILED DESCRIPTION

The example embodiments below concern a search method that combines images and speech together to generate an improved visual search query to increase the relevance of returned visual search results. The examples described below allow users to augment a picture captured, for example, by the camera of a mobile device, with a spoken query. In some example systems, the spoken query is converted to text and a speech search intent is derived from the text at the same time that the visual search intent is derived from the image. The speech search intent may then be used to guide the visual search. Using voice instead of text provides users with a more natural interface for augmenting visual searches than entering a text search, for example, using a soft keyboard of a mobile device. In addition, speaking a search intent may be more natural for a user than typing the search on the soft keyboard, allowing the user to provide more information. Although the embodiments below describe a single image being processed to determine an image search intent, it is contemplated that the image search intent may be generated from a short video sequence, such as a graphics interchange format (GIF) file.

The technical effect of the embodiments described below concerns the concurrent determination of both an image search intent and a speech search intent and the combination of the two intents to generate a search query. These embodiments result in search that is more efficient, providing more relevant information to the user than if either the image search intent or the speech search intent were used alone.

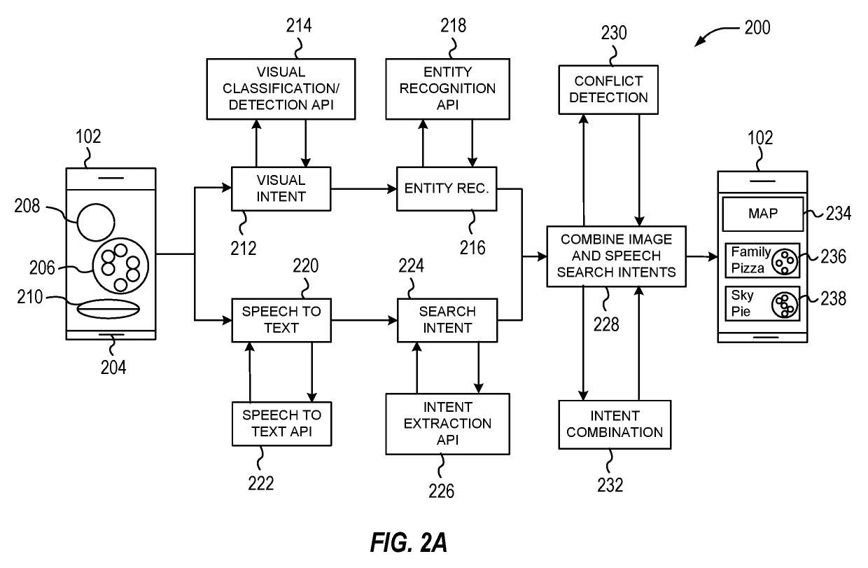

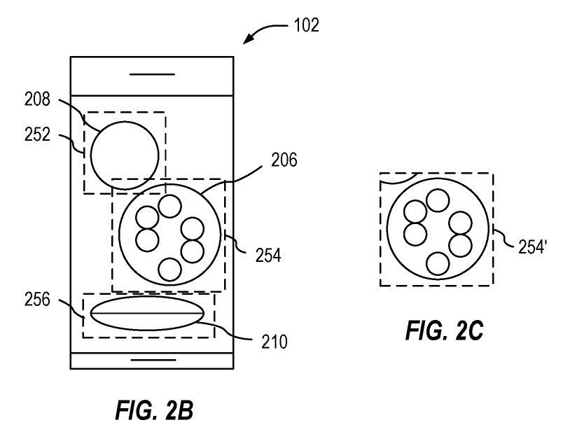

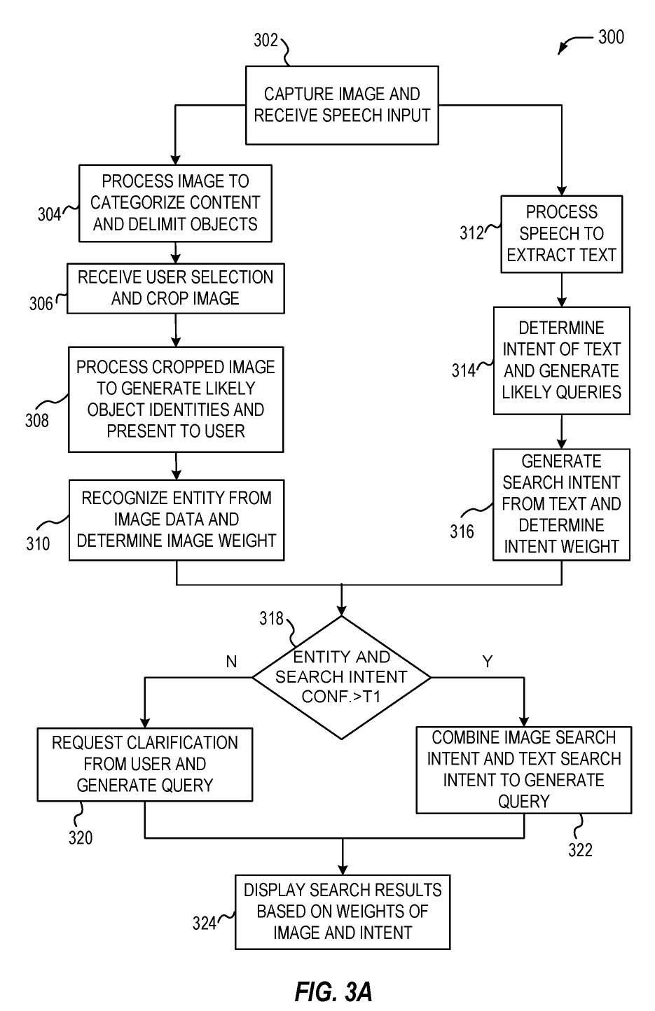

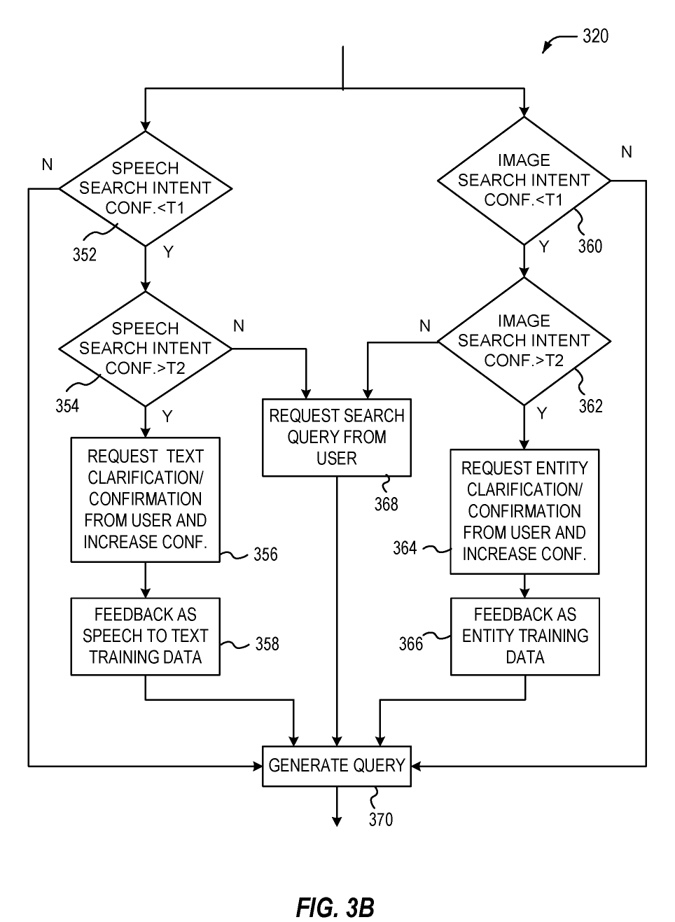

As described in more detail below with reference to FIGS. 2A through 3B, an example computing system generates a search request from a combination of a captured image and captured speech. The system analyzes the image based on visual classification and detection and entity recognition to determine an image search intent. The system also converts the speech to text and analyzes the text to determine a speech search intent. The system then combines the image search intent and the speech search intent to generate a search query. The system presents the results of the query ranked by relevance and by weightings applied to the image search intent and the speech search intent based on their respective confidence values.

As a preliminary matter, some of the figures describe concepts in the context of one or more structural components, variously referred to as functionality, modules, features, elements, or the like. The various components shown in the figures can be implemented in any manner, such as software, hardware, firmware, or combinations thereof. In some cases, various components shown in the figures may reflect the use of corresponding components in an actual implementation. In other cases, any single component illustrated in the figures may be implemented by a number of actual components. The depiction of any two or more separate components in the figures may reflect different functions performed by a single actual component.

Other figures describe the concepts in flowchart form. In this form, certain operations are described as constituting distinct blocks performed in a certain order. Such implementations are examples and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include microprocessors, digital signal processors (DSPs), microcontrollers, computer systems, discrete logic components, and/or custom logic components such as field programmable gate arrays (FPGAs), application specific integrated circuits (ASICs), programmable logic arrays (PLAs) or the like.

As to terminology, the phrase “configured to” encompasses any way that any kind of functionality can be constructed to perform an identified operation. The functionality can be configured to perform an operation using, for example, software, hardware, firmware, or the like. For example, the phrase “configured to” can refer to a logic circuit structure of a hardware element that is arranged to implement the associated functionality. The phrase “configured to” can also refer to a logic circuit structure of a hardware element that is arranged to implement the coding design of associated functionality of firmware or software. The term “module” refers to a structural element that can be implemented using any suitable hardware (e.g., a processor, among others), software (e.g., an application, among others), firmware, and/or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any non-transitory computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

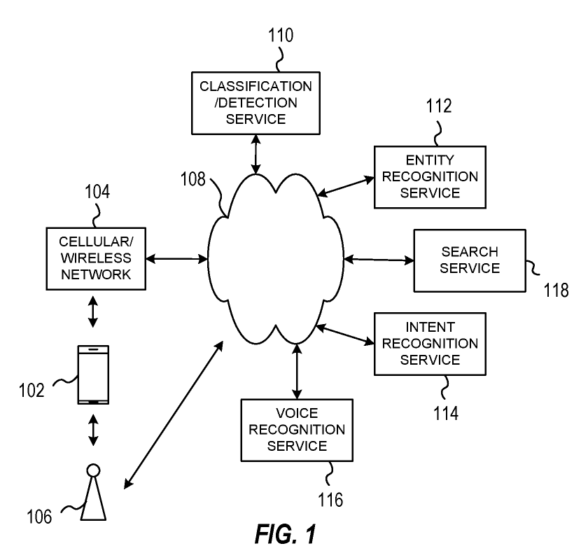

FIG. 1 is a block diagram showing a network environment of the example systems and methods. In the example shown in FIG. 1, a user of a mobile device 102 performs an image search. Although the examples below describe a mobile device performing the search, it is contemplated that other types of devices, such as and without limitation, desktop or laptop computers, wearable computers, or tablet computers may perform similar image searches. The image used in the search may be, without limitation, an image captured by a camera of the device 102, an image obtained from device storage, and/or an image obtained from a previous search, or an image obtained from another user, for example, via a social networking application. As described below with reference to FIG. 2A, the mobile device 102 may be coupled to a wide area network 108 (e.g., the Internet) via a cellular wireless network 104 or by a wireless network, for example a Wi-Fi network, as indicated by the wireless access point 106, operating according to one or more of the IEEE 802.11, IEEE 802.15 or other wireless standards. As described below with reference to FIG. 2A, the mobile device 102 may connect to a classification/detection service 110, an entity recognition service 112, an intent recognition service 114, a voice recognition service 116, and/or a search service 118 via the network 108. Although the services 110, 112, 114, 116 and 118 are shown as separate services running on respective servers, it is contemplated that one or more of them may be combined on a single server. It is also contemplated that at least some of the services, for example, the voice recognition service, may be implemented on the device 102.

FIG. 2A is a functional block diagram of an example visual search application 200 in which the visual search queries may be augmented by a search intent derived from a speech signal. The example application 200 may be implemented as one or more applications on a mobile device or other computing device with a wired, optical, or wireless connection to a network. The example application(s) may access web services, as described below, for example via application program interfaces (APIs). It is contemplated, however, that one or more of the services may be implemented by software running on the device 102.

As shown in FIG. 2A, the application 200 includes two parallel paths, an image path and a voice path. The image path includes a visual intent process 212 that interfaces with a visual classification/detection API 214 and an entity recognition process 216 that interfaces with an entity recognition API 218. As shown in FIG. 1, the visual classification/detection API 214 may provide the application with access to the visual intent web service 110 and the entity recognition API 218 may provide the application with access to the entity recognition service 112.

The voice path includes a speech to text process 220 that interfaces with a speech to text API 222 and a search intent process 224 that interfaces with an intent extraction API 226. Also as shown in FIG. 1, the speech to text API may provide the application with access to the voice recognition service 116, and the intent extraction API may provide the application with access to the intent recognition service 114.

The output data from the image path and the speech path are combined in a process 228 that generates the image search intent augmented with the search intent derived from the speech. The example process 228 uses a process 230 to resolve uncertainties in and/or conflicts between the determined image search intent and the speech search intent. Once any uncertainties/conflicts have been resolved, the application combines the image search intent and speech search intent, using a process 232, to generate a search query. Results of the search query may then be presented on the mobile device 102, in a ranking according to their relevance and according to weights assigned to the image and speech components of the combined search intent. The results may be presented by displaying them on a touch-screen display of the device or they may be presented aurally, using a speaker of the device.

An example system is described in more detail with reference to FIGS. 2A, 2B, 2C, 3A and 3B. FIGS. 3A and 3B are flow-chart diagrams describing an example application 300 running on the mobile device 102. A first block 302 of the application 300 receives the captured image and the speech signal. The image may have been captured by a camera (not shown) of the device 102 or it may have been retrieved from another source such as device storage, a social networking site, an email, a text message, a prior search result, or other image source. The user may initiate the search by speaking a search request into a microphone 204 of the mobile device 204 after capturing the image. Alternatively, the user may initiate the visual search and be prompted by a message on the screen of the mobile device to provide an image and to speak a search request while pressing a talk button (not shown) on the device 102. In some embodiments, the talk button may be a soft key on a touchscreen display of the mobile device or may be a physical switch, for example, on the side of the mobile device. In another example, the user may speak a search request and be prompted by the device 102 to provide an image. As shown in FIG. 2A, for example, the user of the mobile device has captured an image of food including an image 208 of a small cheese pizza, an image 206 of a medium pepperoni pizza and an image 210 of a sandwich. The speech signal corresponding to the image may be, for example, “I want to buy this.”

Once the user starts the search, the application passes the image to the visual intent process 212 and entity recognition process 216 (blocks 304, 306, 308, and 310 in FIG. 3A). The application concurrently passes the speech signal to the speech to text process 220 and search intent process 224 (blocks 312, 314, and 316 in FIG. 3A). Although the example application processes the image and the speech signal concurrently, the materials below describe the image processing first, followed by a description of the speech signal processing.

The visual intent process 212 accesses the visual classification/detection API 214 to determine a general classification of the objects in the image and to automatically draw bounding boxes around the objects (block 304).

The visual classification/detection API 214 accessed by the visual intent process 212 provides an interface to the visual classification/detection service 110. The service 110 may provide an entry level classification of the image as a whole and a detection of objects in the image. This service may provide a general characterization of the scene in the captured image and outline objects in the image with bounding boxes. One example system may provide a broad taxonomy of about 30 categories that include almost everything that may be searched using an image. These are entry level categories, for example, animal, fashion, food_and_drink, plant, sports and other broad categories. Each classification may be accompanied by a confidence value indicating a likelihood that the image belongs to the category. The service 110 may provide multiple categories, each with a corresponding confidence value.

Thus, in the example shown in FIG. 2A and responsive the image shown on the device 102, the classification portion of the classification/detection API 214 may output the major content of the image and confidence values. For the example image, the API 214 may output “food_and_drink (0.99)”, “home_furnishing (0.98)”. The object detection portion of the API 215, responsive to the same image, may output bounding boxes around the major objects in the image and confidence values for the bounding boxes. The detection portion of the API 214 may return the image shown in FIG. 2B with a bounding box 252 around the image 208 of the cheese pizza, a bounding box 254 around the image 206 of the pepperoni pizza and a bounding box 256 around the image 210 of the sandwich. Each of the bounding boxes may be associated with a confidence value (not shown).

The classification portion of the classification/detection service 110 may be implemented as a trained neural network, for example, a convolutional neural network trained by an image database. The object detection portion of the classification/detection service 110 may identify contiguous boundaries in the image and generate bounding boxes that surround those boundaries. Alternatively, the object detection portion may employ a trained neural network that recognizes objects in the image based on extracted features and training data and draws the bounding boxes to surround the recognized objects. Because the classification/detection service 110 classifies images into a relatively small number of categories, it may have a lower latency than a service that attempts to specifically classify individual objects in the image.

After applying the image to the classification/detection API 214, the visual intent process 212 may present the user with the display shown in FIG. 2B and ask the user to select a sub-image to be searched. In this instance, the user may touch the screen to indicate the bounding box 254 containing the image 206 of the pepperoni pizza (block 306 in FIG. 3A). The example visual intent process 212, at block 306, then crops the image to produce the cropped image 254′ shown in FIG. 2C, which is then passed to the entity recognition process 216. The entity recognition process 216, in turn, passes the image 254′ to the entity recognition API 218 (block 308). As an alternative to using the touch-screen display, the device may present each of the delimited in sequence and the user may select the image by pressing a button on the mobile device or indicating the selection by speech.

In block 308, the entity recognition API 218 passes the image 254′ to the entity recognition service 112 to obtain fine grained categories and deep knowledge of the object in the image. The entity recognition service 112 may have multiple components, such as an animal model, a plant model, a food model, a sports activity model, a business activity module, or other classification model. The example system reduces the processing performed by the entity recognition service 112 by using the output of the visual classification/detection service 110 to limit the models applied by the entity recognition service 112 and by sending only the cropped image 254′. The entity recognition service 112 may employ a knowledge base such as Microsoft® Satori® or Google® Knowledge Graph®. An example knowledge base used by the entity recognition service may comprise billions of entities and relationships, providing a useful model of the digital and physical world. To understand the type of information returned, it is helpful to understand how the knowledge bases are built. An example visual knowledge base may use a web crawler to discover image objects within webpages. When the crawler identifies an image object it then may extract information about the object from the webpage and then move on to the next webpage.

Information about a particular object may be obtained from many webpages. When the knowledge base finds another webpage containing the object, it may tag the new webpage with a signature of the object so that it can aggregate information obtained from the new webpage with previously obtained characteristics. Continuing in this manner, the knowledge base may generate a model of the object based on content extracted from many webpages. The gathered characteristics may describe what the object is, how it may be used, and relationships between the object and other objects in the knowledge base. If the captured image indicates an activity, such as bowling, bicycling or swimming, the gathered characteristics may describe the activity.

Thus, the output of the entity recognition API 218 (block 308) for the illustrated example may include a set of image queries based on the pepperoni pizza image 254′. These may include, for example, “where can I buy a pepperoni pizza?,” “how many calories in a slice of pepperoni pizza?” “how can I make a pepperoni pizza?” As shown in block 310, each of these queries may be assigned a confidence value. Although the entity recognition API has narrowed the search to a single object, the result of performing a web search based on all of these queries may produce many irrelevant search results for a user who only wants to buy a pepperoni pizza.

The application 300 shown in FIG. 3A further resolves the search intent by concurrently processing the voice signal captured with the image. After block 302, the application 300 extracts text from the speech signal in block 312. In one example, the application 300 may invoke the speech-to-text API 222 shown in FIG. 2A which, in turn, accesses the voice recognition service 116, shown in FIG. 1. The speech-to-text API may be any of a number APIs such as Bing® Speech or Google Cloud Speech. Block 312 returns a text string corresponding to the speech signal. In the example described above, the returned text is “I want to buy this.”

Text derived from spoken words may not indicate the intent of the search query in a manner that would be understood by a search engine. Thus, the process 300, at block 316, processes the text string to generate one or more search intents and to apply a weight to each of the search intents according to the likelihood of each intent. Block 316, as shown in FIG. 2A, invokes an intent extraction API 226 which, in turn, accesses an intent recognition service 114, shown in FIG. 1. The intent recognition service may use, for example, a web-based cognitive service such as IBM Watson®, Microsoft LUIS®, or Google Cloud Natural Language. These services may, for example, translate the text string “I want to buy this” into the text string “closest location to buy this” or “best price for this.” Alternatively, the services may recognize the word “this” as a pronoun and return strings such as “closest location to buy < >” or “best price for < >,” where the symbol “< >” indicates a position where a noun may be substituted for the pronoun. Each of these strings may be assigned a confidence value, for example, based on the frequency of occurrence of each string in prior search queries.

After generating the visual search intents in block 312 and one or more speech search intents in block 316, the application 300, at block 318 determines whether the entity (image search intent) and the speech search intent of the search are clear. Block 318 may invoke the conflict detection process 230, shown in FIG. 2A, to detect the conflict. The conflict detection process 230 may be a machine learning process that learns to detect conflicts from past submissions by the user and other users. The process 230 may be trained using feedback indicating conflicting image and speech search intents that may be provided directly by the user or may be inferred from actions of the user. Use of user input to train the process 230 is described below with reference to FIG. 3B. Process 230 may infer a conflict, for example, when the user immediately repeats a search request using different language or a different picture, the process 230 may infer a conflict between the speech search intent and image search intent of the immediately previous request. The conflict detection process 230 may include an API (not shown) that invokes a web-based conflict detection service (not shown).

When block 318 indicates that image search intent and the text search intent are clear, for example, when one image search intent and one speech search intent have higher confidence values than any other intents, or when both of the confidence values are greater than a first threshold value T1 (e.g., 0.90-0.99) the application 300 combines the intents to generate a query using the processes 228 and 232 shown in FIG. 2A. In the example, this combined intent may be “closest location to buy a pepperoni pizza.” As described above, for example, the system identified three search intents: “where can I buy a pepperoni pizza?,” “how many calories in a slice of pepperoni pizza?,” and “how can I make a pepperoni pizza?” The first of these intents is compatible with the determined speech search intent of “closest location to buy this.” In this example, the combined search request may be a text string “closest location to buy a pepperoni pizza.” Alternatively, the combined search request may include both text and the image, for example, the image of the pepperoni pizza and the string “closest location to buy.” In another alternative, the search intent may be generated by extracting keywords from the speech search intent (“closest location to buy this”) and the text describing the image search intent (“where can I buy a pepperoni pizza”). In this example, the combined search intent may be “closest location buy pepperoni pizza.” Where multiple image search intents and/or multiple speech search intents have high confidence values (e.g., greater than T1) the system may generate the search query using keywords and/or images from all of the intents having the high-confidence value.

When, however, either or both of the image search intent or text search intent is unclear or conflicting, the application 300 may, at block 320 invoke process 230, shown in FIG. 2A, to clarify the intent or resolve the conflict. A conflict may be detected when the process 230 identified keywords in the image search intent that are incompatible with keywords in the speech search intent. For example, if the voice recognition service 116 had returned the text string “where can I buy fish?” as having a greater confidence value than “where can I buy this?”, the application 300 may determine that a conflict exists because “fish” is incompatible with the returned characteristics of “pepperoni pizza.” In this instance, block 320 may reduce the confidence value for the text string “where can I buy fish?” and/or increase the confidence value for the text string “where can I buy this?” Alternatively, the speech intent may be ignored and the search may proceed based on the image search intent alone. Alternatively, block 320 may ask the user to resolve the conflict between the image search intent and the speech search intent, as described below with reference to FIG. 3B. When conflicting search intents are detected, the process 230 may decrease the confidence values any search intent (speech or image) that the conflicts with the other search intents (image or speech). In some embodiments, the confidence value of the speech search intent may be reduced as it is more likely to be in error than the image search intent which is based on an image provided by the user.

In another example, the captured image or GIF may be of a person riding a bicycle and the recognized text intent may be “where can I do this?” The determined image search intents may include “how to ride a bicycle,” “bicycle stores,” “bike paths,” and “bicycle rentals.” The combination of the speech search intent and the image search intent may reduce the confidence value for the search intents “how to ride a bicycle” and “bicycle stores” but it may be unclear whether the user would like to rent a bicycle or find a bike path.

An unclear intent may be detected when the confidence values of the image intents and/or speech intents are less than the threshold T1. An example process that may be used as the block 320 for resolving unclear intents and training the conflict detection process 230 is shown in FIG. 3B. The application 300 invokes block 320 when the confidence value of either the speech search intent or the image search intent is less than T1. At block 352, the process 320 determines if the speech search intent confidence is less than T1. If it is not, then control passes to block 370 which uses the speech search intent to generate the combined query. If the confidence value of the speech search intent is less than T1, the process 320, at block 354, compares the speech search intent confidence value to a second threshold, T2. A confidence value greater than T2 indicates that the search intent is likely to be correct but not certain. A confidence value less than T2 indicates that the search intent is unclear. Thus, when the speech search intent confidence value is greater than T2, the process 320, at block 356 prompts the user to confirm or correct the speech intent. This may include displaying or announcing the text search intent to the user and asking the user to either confirm the statement or enter a correction. Whether or not the user corrects the text search intent, block 356 increases the confidence value for the speech search intent as it has been either confirmed or corrected by the user. In one example, T1 may be a value in a range from 0.90 to 0.99 and T2 may be a value in a range from 0.80 to 0.89. User corrections of the image and/or speech search intent may be fed back to the conflict detection process 230 along with the uncorrected image and speech search intents to further train the conflict detection process 230.

In block 358, the speech search intent may then be fed back to the voice recognition service 116 and/or the intent recognition service 114 as training data. With reference to FIG. 2A, the user may correct the text search intent by typing in a search intent on a soft keyboard displayed from the application 300 or by speaking a confirmation of the search intent or a corrected search intent into the microphone 204 of the mobile device 102. The application 300 may then invoke the speech to text API 222 to obtain the confirmation or the corrected text. The confirmed or corrected speech search intent is then applied to block 358 for feedback. After block 358, the confirmed or corrected speech search intent is provided to block 370 to generate the query. The query may be generated by combining the image search intent and speech search intent as described above.

The processing of the image intent is similar to the processing of the speech intent. At block 360, the process 320 determines if the confidence value associated with the image search intent is less than T1. If it is not, then control passes to block 370 which uses the image search intent to generate the combined query. If the confidence value of the image search intent is less than T1, the process 320, at block 362, compares the image search intent confidence value to T2. When the image search intent is greater than T2, the process 320, at block 364 prompts the user to confirm or correct the image intent. This may include displaying the cropped image with the entity name, for example displaying the image 254′ shown in FIG. 2C with the text “is this a pepperoni pizza?” Alternatively, the confirmation may be achieved aurally by converting the text to speech to ask the user “is this a pepperoni pizza?” As with the speech search intent, the user may be prompted to confirm or correct the image search intent. After it has been confirmed or corrected, block 364 also increases the confidence value for the image search intent and passes any corrected image search intent to the conflict detection process 230 as training data. In block 366, any corrected image search intent may also be fed back to the classification/detection service 110 and/or to the entity recognition service 112 as training data.

As described above with reference to block 356, the user, responsive to block 360, may correct the entity name (e.g., image search intent) by typing the corrected entity name on a soft keyboard displayed from the application 300 or by speaking a corrected entity name, for example “sausage pizza” into the microphone 204 of the mobile device 102. The application 300 may then invoke the speech to text API 222 to obtain the corrected entity name which is then applied to block 366 for feedback. After block 366, the confirmed or corrected speech search intent is provided to block 370 to generate the query.

When the confidence values of both the speech search intent and the image search intent are less than T2, the process 320, at block 368, does not have sufficient confidence in either search intent and may display a prompt requesting a search query from the user. Block 320 may or may not combine the speech and image search intents. Block 320 may, for example, display text such as “unable to generate search query” and provide the user with a window in which to manually enter the query. As described above, the application 300 may display a soft keyboard and/or allow the user to use speech to enter the query. The entered query along with the image search intent and speech search intent may be fed back to one or more of the voice recognition service 116, intent recognition service 114, entity recognition service 112, classification/detection service 110, and/or conflict detection process 230 to be used as training data.

Referring to FIG. 3A, after generating the search query either in block 320 or 322, the process 300 sends the search query to the search service 118 and, at block 324 receives the search results. Block 324 presents the search results to the user in an order determined from the confidence values of the speech search intent(s) and/or image search intent(s). As shown in FIG. 2A, when the combined search intent is “closest location to buy a pepperoni pizza” the results may be displayed as a map 234 showing locations of nearby pizza parlors and informational links 236 and 238 to each entry on the map. Alternatively, the results may be provided aurally. In either instance, a user may select a location and request directions to the location. In this instance, the selected location is provided to a mapping application on the device.

Combining a visual search intent with a speech search intent provides advantages over searching based on either intent alone. As described above, the combined search intent may be more focused, providing few and more relevant search results. In addition, if the application 300 detects conflicts between the search intents or uncertainty in one or both of the search intents, it can request confirmation and/or correction before proceeding. The use of a speech signal to refine a visual search request may provide a more satisfying search experience, especially for small mobile devices, such as smart phones, where text entry using a small soft keyboard may be awkward.

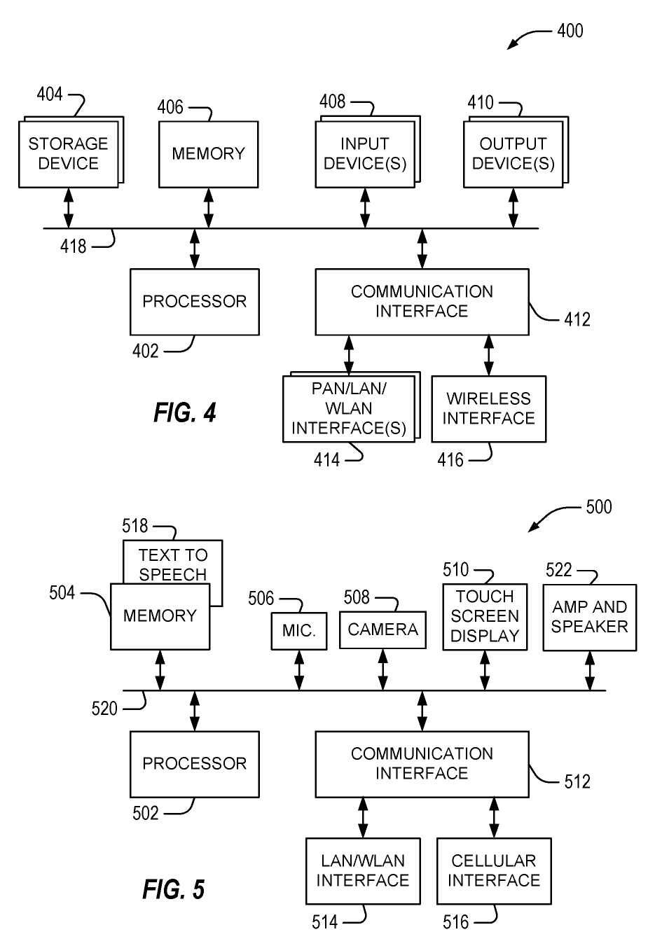

FIG. 4 is a block diagram of an example processing system 400 that may be used as any of the servers 110, 112, 114, 116, and 118 shown in FIG. 1. The system 400 includes a processor 402 coupled to a bus 418. Also coupled to the bus 418 are one or more storage devices 404 (e.g. a flash memory or a disk storage device); a memory 406, which may include random access memory (RAM) and read only memory (ROM); one or more input devices 408 (e.g. a keyboard, a touchscreen, or a microphone); one or more output devices 410 (e.g. a display screen or a speaker) and a communications interface 412 to provide communication between the system 400 and other systems as described above with reference to FIG. 1.

The memory 406 may store computer instructions for applications that are currently running on the system 400. The storage device 404 may include a database that may be local to the system 400 or located remotely, for example in a cloud storage server (not shown).

In FIG. 4 the communications interface includes an interface 414 coupled to a wide area network (WAN), for example, the Internet, a personal area network (PAN), a local area network (LAN) interface such as a wired or optical Ethernet connection and/or a wireless LAN (WLAN) or wireless connection (e.g. IEEE 402.11 or IEEE 402.15). In addition the communications interface 412 may be coupled to a wireless interface 416 such as a cellular mobile device interface. The interfaces 414 and 416 may be coupled to respective transceivers and/or modems (not shown) to implement the data communications operations.

Processor 402 may include a single core or multi-core microprocessor, microcontroller, digital signal processor (DSP) that is configured to execute commands stored in the memory 406 corresponding to the programs (Internet browsers, application program interfaces (APIs), dynamically linked libraries (DLLs), or applications (APPs)) described above. The memory 406 may also store temporary variables or other information used in the execution of these programs. The programs stored in the memory 406 may be retrieved by the processor from a physical machine-readable memory, for example, the storage device 404, or from other computer readable media such as a CD-ROM, digital versatile disk (DVD) or flash memory.

FIG. 5 is a block diagram of an example processing system 500 that may be used as the mobile device 102 shown in FIG. 1. The system 500 includes a processor 502 coupled to a bus 520. Also coupled to the bus 520 are a memory 504, which may include a flash memory device, random access memory (RAM) and/or read only memory (ROM); a microphone 506, a camera 508, an input and/or output device 510, such as a touch screen display, and an amplifier and speaker 522. The bus 520 also connects the system 500 to a communications interface 512 to provide communication between the system 500 and the cellular wireless network 106, Wi-Fi network 116, shown in FIG. 1, or other network for example, a wired LAN. It is contemplated that the amplifier and speaker 522 may be coupled directly to an analog output port of the processor 502 rather than to the bus 520.

The memory 504 may store computer instructions for applications that are currently running on the system 500. The communications interface 512 may be coupled to a LAN/WLAN interface 514 such as a wired or optical Ethernet connection or wireless connection (e.g. IEEE 502.11 or IEEE 502.15). In addition the communications interface 512 may be coupled to a wireless interface such as a cellular interface 516. The interfaces 514 and 516 may be coupled to respective transceivers and/or modems (not shown) to implement the data communications operations. As described above, one of the applications stored in the memory may be a text-to-speech application 518 to provide an aural interface via the speaker 522.

Processor 502 may include a microprocessor, microcontroller, digital signal processor (DSP) that is configured to execute commands stored in the memory 504 corresponding to the programs (Internet browsers, application program interfaces (APIs), dynamically linked libraries (DLLs), or applications (APPs)) described above. The memory 504 may also store temporary variables, the clipboard, or other information used in the execution of these programs. The programs stored in the memory 504 may be retrieved by the processor from a separate computer readable media, for example, a flash memory device, a CD-ROM, or digital versatile disk (DVD).

### EXAMPLES

### Example 1

In one example, an apparatus for augmenting a visual search using a speech signal includes a microphone; a memory containing program instructions; a processor coupled to the memory, and the microphone, wherein the processor is configured by the program instructions to: receive image data for the visual search; process the image data to determine an image search intent; receive a speech signal from the microphone; process the speech signal, concurrently with the processing of the image data, to determine a speech search intent; generate a search query by combining the image search intent and the speech search intent; initiate a search based on the generated search query; receive search results; and cause the search results to be presented to a user.

In another example, the processor is configured by the program instructions to: classify the image data to determine an entry level classification of the image; process the image to delimit objects in the image; display the processed image; receive a selection of one of the delimited objects in the image from the touch-screen display; crop the image to extract a cropped image of the selected object; and determine the image search intent based on the cropped image and the entry level classification of the image.

In yet another example, the program instructions configure the processor to determine the image search intent based on the cropped image and the entry level classification of the image by configuring the processor to initiate a search for the cropped image in a knowledge base, wherein the search of the knowledge base is limited by the entry level classification of the image.

In another example, the program instructions configure the processor to determine the image search intent based on the cropped image and the entry level classification of the image by further configuring the processor to receive, from the knowledge base, as the image search intent, a plurality of image search intents, each of the plurality of image search intents associated with a respective confidence value.

In yet another example, the program instructions further configure the processor to determine, from the respective confidence values of the plurality of image search intents that none of the plurality of image search intents is clear; and to generate a prompt requesting confirmation or correction of at least one image search intent of the plurality of image search intents.

In another example, the program instructions that configure the processor to initiate the search based on the generated search query configure the processor to: select multiple image search intents from the plurality of image search intents based on the respective confidence values; generate the search query by combining keywords from the multiple image search intents and the speech search intent; wherein the program instructions that configure the processor to present the results of the search include program instructions that configure the processor to cause the search results containing keywords from the multiple image search intents to be presented in an order determined by the respective confidence values of the multiple image search intents.

In another example, the program instructions that configure the processor to process the speech signal to determine the speech search intent include program instructions that cause the processor to: perform a speech to text operation to convert the speech signal to a text string; apply the text string to a web-based cognition service; and receive, from the web-based cognition service, at least one further text string representing the speech search intent and at least one corresponding confidence value for the at least one further text string.

In another example, the program instructions that configure the processor to combine the image search intent and the speech search intent to generate the search query include program instructions that cause the processor to: determine that at least one of the image search intent and the speech search intent is unclear; and generate a prompt requesting clarification of the at least one of the image search intent or the speech search intent.

In yet another example, the program instructions that configure the processor to combine the image search intent and the speech search intent to generate the search query include program instructions that cause the processor to include the cropped image and keywords extracted from the speech search intent in the generated search query.

In another example, the apparatus further includes a text-to-speech application and a speaker and the processor is further configured to: extract text from the received search results; convert the extracted text to speech using the text-to-speech application; and present the converted speech to the user.

### Example 2

In one example, a method for using a speech signal to augment a visual search, the method includes: receiving, by a computing device, image data for the visual search; processing, by the computing device, the image data to determine at least one image search intent; processing, by the computing device, the speech signal, concurrently with the processing of the image data, to determine at least one speech search intent; generating a search query by combining keywords from the at least one image search intent and the at least one speech search intent; initiating, by the computing device, a search based on the generated search query; and receiving and reporting, by the computing device, results of the search.

In another example, processing the image data includes: classifying the image data to determine an entry level classification of the image; processing the image to delimit objects in the image; displaying the processed image; receiving a selection of one of the delimited objects in the image; cropping the image to extract a cropped image of the selected object; and determining the at least one image search intent based on the cropped image and the entry level classification of the image.

In yet another example, determining the image search intent based on the cropped image and the entry level classification of the image includes initiating a search for the cropped image in a knowledge base, wherein the search of the knowledge base is limited by the entry level classification of the image.

In another example, the method includes receiving, from the knowledge base, as the at least one image search intent, a plurality of image search intents, each of the plurality of image search intents associated with a respective confidence value.

In another example, the method further includes: determining, from the respective confidence values of the plurality of image search intents that none of the plurality of image search intents is clear; and generating a prompt requesting confirmation or correction of one of the plurality of image search intents having a largest confidence value.

In another example, the at least one image search intent includes multiple image search intents and the at least one speech search intent includes multiple speech search intents; generating the search query includes combining keywords from the multiple image search intents and the multiple speech search intent; and the receiving and reporting of the results of the search includes reporting the search results in an order determined by the respective confidence values of the multiple image search intents and the multiple speech search intents.

In another example, processing the speech signal to determine the speech search intent includes: performing a speech to text operation to convert the speech signal to a text string; applying the text string to a web-based cognition service; and receiving, from the web-based cognition service, at least one further text string representing the at least one speech search intent and at least one corresponding confidence value.

In yet another example, combining the at least one image search intent and the at least one speech search intent to generate the search query includes: determining that the at least one image search intent or the at least one speech search intent is unclear; and generating a prompt requesting clarification of at the least one of the image search intent or the at least one speech search intent.

In another example, generating the search query includes combining the cropped image, the keywords extracted from the at least one speech search intent, and the keywords extracted from the at least one image search as the search query.

In yet another example, reporting the results of the search includes: extracting text from the received search results; converting the extracted text to speech using the text-to-speech application; and presenting the converted speech to the user.

### Example 3

In one example, a computer program product for using a speech signal to augment a visual search, the computer program product including a memory containing program instructions that, when executed by a processor configure the processor to: receive image data for the visual search; process the image data to determine at least one image search intent; process the speech signal, concurrently with the processing of the image data, to determine at least one speech search intent; generate a search query by combining keywords from the at least one image search intent and the at least one speech search intent; initiate, a search based on the generated search query; and receive and report results of the search.

In another example, the program instructions configure the processor to: classify the image data to determine an entry level classification of the image; process the image to delimit objects in the image; display the processed image; receive a selection of one of the delimited objects in the image; crop the image to extract a cropped image of the selected object; and determine the at least one image search intent based on the cropped image and the entry level classification of the image.

In another example, the program instructions further configure the processor to determine the image search intent based on the cropped image and the entry level classification of the image by configuring the processor to initiate a search for the cropped image in a knowledge base, wherein the search of the knowledge base is limited by the entry level classification of the image.

In yet another example, the program instructions that configure the processor to process the speech signal further configure the processor to: perform a speech to text operation to convert the speech signal to a text string; apply the text string to a web-based cognition service; and receive, from the web-based cognition service, at least one further text string representing the at least one speech search intent.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the scope of the appended claims.

In particular and in regard to the various functions performed by the above described components, devices, circuits, systems and the like, the terms used to describe such components are intended to correspond, unless otherwise indicated, to any component which performs the specified function of the described component, e.g., a functional equivalent, even though not structurally equivalent to the disclosed structure, which performs the function in the example illustrated aspects of the claimed subject matter. In this regard, it will also be recognized that the disclosed example embodiments and implementations include a system as well as computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned example systems have been described with respect to interaction among several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

Furthermore, while a particular feature of the claimed subject matter may have been disclosed with respect to one of several implementations, such feature may be combined with one or more other features of the other implementations as may be desired and advantageous for any given or particular application. In addition, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. Apparatus for augmenting a visual search using a speech signal, the apparatus comprising:
a microphone;
a memory containing program instructions;
a processor coupled to the memory, and the microphone, wherein the processor is configured by the program instructions to:
receive image data for the visual search;
process the image data to determine an image search intent;
receive a speech signal from the microphone;
process the speech signal, concurrently with the processing of the image data, to determine a speech search intent;
generate a search query by combining the image search intent and the speech search intent;
initiate a search based on the generated search query;
receive search results; and
cause the search results to be presented to a user.

2. The apparatus of claim 1, wherein, to process the image data, the processor is configured by the program instructions to:
classify the image data to determine an entry level classification of the image;
process the image to delimit objects in the image;
present the delimited objects on a display;
receive a selection of one of the delimited objects;
crop the image to extract a cropped image of the selected object; and
determine the image search intent based on the cropped image and the entry level classification of the image.

3. The apparatus of claim 2, wherein the program instructions configure the processor to determine the image search intent based on the cropped image and the entry level classification of the image by configuring the processor to initiate a search for the cropped image in a knowledge base, wherein the search of the knowledge base is limited by the entry level classification of the image.

4. The apparatus of claim 3, wherein the program instructions configure the processor to determine the image search intent based on the cropped image and the entry level classification of the image by further configuring the processor to receive, from the knowledge base, as the image search intent, a plurality of image search intents, each of the plurality of image search intents associated with a respective confidence value.

5. The apparatus of claim 4, wherein the program instructions further configure the processor to:
determine, from the respective confidence values of the plurality of image search intents that none of the plurality of image search intents is clear; and
generate a prompt requesting confirmation or correction of at least one image search intent of the plurality of image search intents.

6. The apparatus of claim 4, wherein the program instructions that configure the processor to initiate the search based on the generated search query configure the processor to:
select multiple image search intents from the plurality of image search intents based on the respective confidence values;
generate the search query by combining keywords from the multiple image search intents and the speech search intent;
wherein the program instructions that configure the processor to present the results of the search include program instructions that configure the processor to cause the search results containing keywords from respective ones of the multiple image search intents to be presented in an order determined by the respective confidence values of the respective multiple image search intents.

7. The apparatus of claim 1, wherein program instructions that configure the processor to process the speech signal to determine the speech search intent include program instructions that cause the processor to:
perform a speech to text operation to convert the speech signal to a text string;
apply the text string to a web-based cognition service; and
receive, from the web-based cognition service, at least one further text string representing the speech search intent and at least one corresponding confidence value for the at least one further text string.

8. The apparatus of claim 7, the program instructions that configure the processor to combine the image search intent and the speech search intent to generate the search query include program instructions that cause the processor to:
determine that at least one of the image search intent and the speech search intent is unclear; and
generate a prompt requesting clarification of the at least one of the image search intent or the speech search intent.

9. The apparatus of claim 1, wherein the program instructions that configure the processor to combine the image search intent and the speech search intent to generate the search query include program instructions that cause the processor to include the cropped image and keywords extracted from the speech search intent in the generated search query.

10. The apparatus of claim 1, further comprising a text-to-speech application and a speaker and the processor is further configured to:
extract text from the received search results;
convert the extracted text to speech using the text-to-speech application; and
present the converted speech to the user.

11. A method for using a speech signal to augment a visual search, the method comprising:
receiving, by a computing device, image data for the visual search;
processing, by the computing device, the image data to determine at least one image search intent;
processing, by the computing device, the speech signal, concurrently with the processing of the image data, to determine at least one speech search intent;
generating a search query by combining keywords from the at least one image search intent and the at least one speech search intent;
initiating, by the computing device, a search based on the generated search query; and
receiving and reporting, by the computing device, results of the search.

12. The method of claim 11, wherein processing the image data includes:
classifying the image data to determine an entry level classification of the image;
processing the image to delimit objects in the image;
displaying the processed image;
receiving a selection of one of the delimited objects in the image;
cropping the image to extract a cropped image of the selected object; and
determining the at least one image search intent based on the cropped image and the entry level classification of the image.

13. The method of claim 11, wherein determining the image search intent based on the cropped image and the entry level classification of the image includes initiating a search for the cropped image in a knowledge base, wherein the search of the knowledge base is limited by the entry level classification of the image.

14. The method of claim 13, further comprising receiving, from the knowledge base, as the at least one image search intent, a plurality of image search intents, each of the plurality of image search intents associated with a respective confidence value.

15. The method of claim 14, further comprising:
determining, from the respective confidence values of the plurality of image search intents that none of the plurality of image search intents is clear; and
generating a prompt requesting confirmation or correction of one of the plurality of image search intents having a greatest confidence value.

16. The method of claim 11, wherein:
the at least one image search intent includes multiple image search intents and the at least one speech search intent includes multiple speech search intents;
generating the search query includes combining keywords from respective ones of the multiple image search intents and the multiple speech search intent; and
the receiving and reporting of the results of the search includes reporting the search results in an order determined by the respective confidence values of the respective multiple image search intents and the multiple speech search intents.

17. The method of claim 11, wherein processing the speech signal to determine the speech search intent includes:
performing a speech to text operation to convert the speech signal to a text string;
applying the text string to a web-based cognition service; and
receiving, from the web-based cognition service, at least one further text string representing the at least one speech search intent and at least one corresponding confidence value.

18. The method of claim 11, wherein combining the at least one image search intent and the at least one speech search intent to generate the search query includes:
determining that the at least one image search intent or the at least one speech search intent is unclear; and
generating a prompt requesting clarification of at the least one of the image search intent or the at least one speech search intent.

19. The method of claim 11, wherein generating the search query includes combining the cropped image, the keywords from the at least one speech search intent, and the keywords from the at least one image search as the search query.

20. The method of claim 11, wherein reporting the results of the search includes:
extracting text from the received search results;
converting the extracted text to speech using the text-to-speech application; and
presenting the converted speech to the user.

21. A computer program product for using a speech signal to augment a visual search, the computer program product including a memory containing program instructions that, when executed by a processor configure the processor to:
receive image data for the visual search;
process the image data to determine at least one image search intent;
process the speech signal, concurrently with the processing of the image data, to determine at least one speech search intent;
generate a search query by combining keywords from the at least one image search intent and the at least one speech search intent;
initiate, a search based on the generated search query; and
receive and report results of the search.

22. The computer program product of claim 21, wherein the program instructions further configure the processor to:
classify the image data to determine an entry level classification of the image;
process the image to delimit objects in the image;
display the processed image;
receive a selection of one of the delimited objects in the image;
crop the image to extract a cropped image of the selected object; and
determine the at least one image search intent based on the cropped image and the entry level classification of the image.

23. The computer program product of claim 21, wherein the program instructions further configure the processor to determine the image search intent based on the cropped image and the entry level classification of the image by configuring the processor to initiate a search for the cropped image in a knowledge base, wherein the search of the knowledge base is limited by the entry level classification of the image.

24. The computer program product of claim 21, wherein the program instructions that configure the processor to process the speech signal further configure the processor to:
perform a speech to text operation to convert the speech signal to a text string;
apply the text string to a web-based cognition service; and
receive, from the web-based cognition service, at least one further text string representing the at least one speech search intent.
